(19) United States
(12) Patent Application Publication
(10) Pub. No.: US 2006/0115560 A1
(43) Pub. Date: Jun. 1, 2006

(54) Treatment of meat

(75) Inventors: John B. Long, Sarasota, FL (US); Peter Thomsen, Richland, WA (US)

Correspondence Address: BROWDY AND NEIMARK, P.L.L.C.;624 NINTH STREET, NW, SUITE 300, WASHINGTON, DC, 20001-5303, US

(73) Assignee: HYRDODYNE INCORPORATED, Sarasota, FL (US)

(21) Appl. No.: 11/283,533

(22) Filed: Nov. 21, 2005

Related U.S. Application Data
(60) Provisional application No. 60/629,324, filed on Nov. 19, 2004.

(51) Int. Cl. A23B 4/056

(52) U.S. Cl. 426/235

(57) ABSTRACT

Meat is treated in a confined space to tenderize the meat and/or kill bacteria in or on the meat, the confined space being either evacuated to remove any air bubbles, or flushed with an oxygen-free and non-toxic gas to flush away any air or oxygen.

The present invention relates to improvements in the treatment of meat, especially in the treatment of meat by the Hydrodyne process to tenderize such meat by subjecting such meat to a shockwave, such as in accordance with the patents and patent applications of John Long.

The disclosure of Long U.S. Pat. No. 6,669,546 and Long et al application Ser. No. 10/714,908, now U.S. publication no. 2004/0097180 A1, are herein incorporated by reference.

While earlier embodiments of the Hydrodyne system have functioned very well to tenderize tough grades of meat and also kill a very large proportion of bacteria which may exist in or on the meat, one problem has persisted. Thus, in spite of compressing the meat in the zone in which it is subjected to the shockwave, such compression squeezing out all or most of the air within the meat treatment chamber, sometimes small pockets of air remain. Air, of course contains about 21% oxygen. When the air is compressed and the meat is subjected to a shockwave, heating of the air occurs which on occasion is sufficient to cause localized burning of the meat or fat adjacent the air bubble. While such a burning causes no deleterious effect, it would of course be desirable to avoid such burning for aesthetic and thus commercial reasons.

The meat in the meat treatment chamber of the presently preferred embodiment of the Hydrodyne system, as disclosed for example in Long U.S. Pat. No. 6,669,546 and Long et al 2004/0097180, is in contact with shock wave reflective and containing walls, e.g. stainless steel on five sides, and with a shock wave transparent diaphragm through which the shock wave passes on the sixth side. Because of the natural irregularities on the meat surfaces, when the meat is compressed in the meat treatment chamber, small areas trap air where depressions in the meat occur as noted above. When the shock wave passes through the shock wave transparent diaphragm and into the meat, the trapped air in the depression is compressed and as a result increases in temperature. In some instances, as noted above, the temperature of the gas is sufficient to produce surface burning. The result is an undesirable change in appearance in those areas as well as the production of a burned odor, and in extreme cases a change in flavor.

According to the present invention, the environment in the meat treatment chamber is changed to one that prevents any oxidation. This is accomplished in either of two ways. The first is to evacuate the meat treatment chamber after the meat is introduced and prior to the introduction of the shock wave. The second is to fill the meat treatment chamber with a non-oxidizing gas, prior to the introduction of the meat. There are several choices of gas. The noble inert gases, of which argon is an example, are non toxic and will prevent oxidation. The second is carbon dioxide, which in this case is non oxidizing and non toxic. Both argon and carbon dioxide are commonly used in welding and have no bad effects on workers in the area.

Accordingly, the present invention solves the aforementioned problem in either of two ways, i.e. by evacuating the treatment chamber, or flooding the meat with a suitable oxygen-free gas so that whatever pockets of gas may exist upon compression of the meat in the treatment chamber, such pockets will be free of oxygen and thus avoid the aforementioned problem.

The presently preferred gas is carbon dioxide, but any non-toxic gas could be used, e.g. an inactive gas such as argon or nitrogen, or any other non-toxic gas which will not generate oxygen and will not deleteriously affect the meat.

### EXAMPLES

Several trials were run using the apparatus disclosed in the aforementioned Long et al application Ser. No. 10/714,908, except that the cuts of meat were flooded with carbon dioxide. Various cuts of meat were used, some of which had a very rough outer contour. The meat was inspected after shock wave treatment according to the Hydrodyne system. Upon inspection, the cuts of meat so treated had no traces of burned appearance and no traces of smell from burning.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. For example, other meat treatment chambers than those described above may be used in accordance with the present invention. Thus it is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. In a method of treating meat by subjecting said meat to a shock wave in a confined space meat treatment chamber to tenderize said meat and/or kill bacteria on or in said meat, the improvement wherein
said meat is freed of any air pockets in the meat treatment chamber.

2. The method according to claim 1 wherein said meat is subjected to vacuum to eliminate any air pockets in the meat treatment chamber.

3. The method in accordance with claim 1, wherein said meat is subjected to treatment with an oxygen-molecule free and non-toxic gas which does not deleteriously affect the meat, thereby flushing away any air or oxygen so that said meat in the meat treatment chamber is free of any pockets of air or oxygen.

4. The method of claim 3, wherein the gas is carbon dioxide, nitrogen or argon.

5. An apparatus for carrying out the method of claim 1 comprising means for drawing vacuum from the meat treatment chamber or a zone adjacent or near the meat treatment chamber so that any air or oxygen in the meat treatment chamber is evacuated so that the meat in the meat treatment chamber is free of air or oxygen.

6. An apparatus for carrying out the method of claim 1 comprising means for feeding an oxygen-molecule-free and non-toxic gas to the meat treatment chamber or a zone adjacent the meat treatment chamber so that the meat in the meat treatment chamber is flushed free of air or oxygen.
